(19) United States
(12) Patent Application Publication
(10) Pub. No.: US 2010/0200766 A1
(43) Pub. Date: Aug. 12, 2010

(54) ELECTRON EMITTER HAVING NANO-STRUCTURE TIP AND ELECTRON COLUMN USING THE SAME

(76) Inventor: Ho Seob Kim, Incheon (KR)

Correspondence Address: PARK LAW FIRM, 3255 WILSHIRE BLVD, SUITE 1110, LOS ANGELES, CA, 90010, US

(21) Appl. No.: 12/670,703

(22) PCT Filed: Jul. 28, 2008
(86) PCT No.: PCT/KR08/04390

§ 371 Date: Jan. 26, 2010

(30) Foreign Application Priority Data
Jul. 26, 2007 (KR) 10-2007-0075322

(51) Int. Cl. H01J 31/00; H01J 3/14; H01J 3/26; H01J 1/02

(52) U.S. Cl. 250/396 R; 313/346 R; 977/939; 977/762; 977/742; 977/773

(57) ABSTRACT

The present invention relates to an electron emitter having a nanostructure tip and an electron column using the same, and, more particularly, to an electron emitter which includes a nanostructure tip which can easily emit electrons, composed of carbon nanotube (CNT), zinc oxide nanotube (ZnO nanotube), zinc oxide nanorod, zinc oxide nanopillar, zinc oxide nanowire, zinc oxide nanoparticle or the like, and an electron column using the same.

### TECHNICAL FIELD

The present invention relates to an electron emitter having a nanostructure tip and an electron column using the same, and, more particularly, to an electron emitter which includes a nanostructure tip which has a tubular, columnar or blocky structure of from several nanometers to several tens of nanometers, which is composed of materials such as carbon nanotube (CNT), zinc oxide nanotube (ZnO nanotube), zinc oxide nanorod, zinc oxide nanopillar, zinc oxide nanowire, zinc oxide nanoparticle or the like, and which can easily emit electrons because a high electric field is formed at the end of the nanostructure tip when a voltage is applied to the nanostructure tip, and which can be easily aligned with other electron lenses and can be easily used.

Further, the present invention relates to an electron column fabricated using the electron emitter, and, more particularly, to an electron column fabricated using the electron emitter, which can be easily fabricated into a single electron column as well as a multi electron column.

### BACKGROUND ART

An electron emitter related to the present invention, serving to emit electrons, is used as an electron beam source for appliances or apparatuses, for example, a miniaturized electron beam column or microcolumn.

A miniaturized electron beam column, which is fabricated based on an electron emitter and a microstructural electron optics device, operating under the basic principle of a scanning tunneling microscope (STM), was first introduced in the 1980's. The miniaturized electron beam column can be improved the column performance by precisely fabricated microlenses and assembling minute parts to minimize optical aberration, and a plurality of electron columns can be used as an arrayed multiple electron column by arranging them in parallel or in series.

FIG. 1 is schematic sectional view showing the structure of a miniaturized electron beam column. An electron emitter, source lenses, a deflector and einzel lenses aligned in an axis. An electron beam is scanned by the deflector.

Generally, a microcolumn, which is a typical example of a miniaturized electron beam column, includes an electron emitter 10 for emitting electrons, source lenses 20 for forming the electrons emitted from the electron emitter 10 into an electron beam (B), a deflector 30 for deflecting the electron beam (B), and focus lenses 40 (einzel lenses 40) for focusing the electro beam (B) on a specimen (S).

Examples of the electron emitter, which is one of the essential components in conventional electron columns or in electron microscopes, include a field emitter (FE), a thermal emitter (TE), a Schottky emitter as a thermal field emitter (TFE), and the like. An ideal electron emitter requires stable electron emission, high brightness, small virtual beam size, high current density emission, low energy spread, and long life-time.

Examples of the electron column include a single electron column including an electron emitter and electron lenses for controlling an electron beam emitted from the electron emitter, and a multi electron column including an array of electron emitters and an array of electron lenses for controlling an array of electron beams emitted from the array of electron emitters.

Examples of the multi electron column may include wafer-scale electron columns including electron emitters provided with an array of electron emitter tips formed on a substrate, such as a semiconductor wafer, and electron lenses provided with a lens layer having an array of apertures formed in a wafer-substrate; a combination type electron column controlling an electron beam emitted from each electron emitter using a lens layer having an array of apertures, as in the single electron column; and a mounting type electron column provided with a housing in which the single electron columns are mounted. The combination type electron column can be used in the same manner as the wafer type electron column, except for the difference that the electron emitters are separately divided.

As such, an electron emitter is an important component of a microcolumn, and has a very important use as an electron beam source in various fields using an electron beam, such as electron beam lithography, electron microscopes, field emission displays (FEDs), scanning field emission display (SFEDs), and the like.

Further, in the fields of electron columns or other apparatuses or equipment using an electron beam, only when an electron emitter is accurately aligned at the center of an optical axis of an electron lens (particularly, a source lens), an electron column or an apparatus or equipment using an electron beam can exhibit the maximum performance. For this, a tip of an electron emitter must be well aligned on the optical axis of an electron lens, and the tip itself must be correspondingly fabricated or formed along the optical axis of an electron lens. When the tip itself is not correspondingly fabricated or formed along the optical axis of an electron lens, it is difficult to correct the other fabricated or formed tip, and additional parts or control processes are required in order to correct the fabricated or formed tip.

In particular, in the field of semiconductors and displays, the structure of a device becomes microscopic and large in area. As a technology or apparatus for precisely and rapidly processing, measuring and inspecting such a microstructure, various apparatuses using an electron beam are being increasingly required, and concomitantly a multi electron column is being more increasingly required, and thus an electron emitter corresponding to a multi electron column is also being more required.

Therefore, there is a need for an electron emitter which satisfies the necessary required functionality of an electron emitter, and which can be well aligned and suitably used even in single electron columns and multi electron columns.

### DISCLOSURE OF INVENTION

### Technical Problem

Accordingly, the present invention has been made keeping in mind the above problems occurring in the prior art, and an object of the present invention is to provide an electron emitter having a nanostructure tip, which can emit electrons even at low voltage and can be easily fabricated and used, unlike conventional electron emitters being used in electron columns or electron beam irradiation apparatuses.

Another object of the present invention is to provide a method of easily aligning, adhering and depositing the nanostructure tip of the electron emitter, and an electron column using the electron emitter.

A further object of the present invention is to provide an electron emitter having the nanostructure tip, which can readily be aligned with electron lenses.

### Technical Solution

In order to accomplish the above objects, the present invention provides an electron emitter, including: a substrate including a blind hole (concave or well) or a protrusion formed at a predetermined location thereof; a catalyst layer or an adhesive layer attached to the hole or protrusion; and a nanostructure tip grown and adhered on the catalyst layer or adhesive layer.

In the present invention, the nanostructure tip is made of at least one atom, such as carbon (C), zinc (Zn), gold (Au), silver (Ag), silicon (Si), tungsten (W), oxygen (O), and etc. Further, the nanostructure tip can be fabricated in the form of nanotube, nanorod, nanopillar, nanowire, or nanoparticle having a size on the order of nanometers. When a voltage is applied to such a nanostructure, a high electric field is formed at the top of the nanostructure, and thus a large number of electrons can be easily emitted therefrom. That is, since nanosized materials can easily emit electrons, a nanostructure tip for directly emitting electrons is fabricated using the nanosized materials, and this nanostructure tip is used in an electron emitter through a deposition, growing or adhering process. Examples of this nanostructure include carbon nanotube (CNT), zinc oxide nanotube (ZnO nanotube), zinc oxide nanorod, zinc oxide nanopillar, zinc oxide nanowire, zinc oxide nanoparticle, silicon oxide (SiO nanorod), gold (Au) nanoparticle, aluminum (Al) nanoparticle, copper (Cu) nanoparticle, gallium-antimony (Ga—Sb) nanoparticle, niobium oxide (Nb₂O₅) nanotube-nanopillar, palladium (Pd) nanotube, and the like.

In a method of fabricating the electron emitter, first, a hole or protrusion is formed by etching or depositing a substrate, and then a nanostructure tip is formed on the hole or protrusion. In this case, the hole or protrusion is formed into a membrane, which is a thin film, through a lithography process, and light or laser passes through the membrane. Here, the thickness of the membrane is not limited as long as the nanostructure tip may be stably attached to the membrane, and as long as the form of a lens hole located at the lower end of the membrane can be distinguished through light or laser having passed through an aperture of a lens. This membrane may be formed by etching or polishing. The thickness and size of the substrate located beneath the hole or protrusion is in a range of several nanometers to several tens of nanometers. It is preferred that the hole or protrusion have a shape corresponding to that of a hole or aperture of a electron lens, for example, a circular shape. The hole or protrusion is coated with a catalyst, and a nanostructure tip is adhered or grown on the catalyst. The nanostructure tip can be accurately formed through a lithography process.

The nanostructure tip may be deposited on the hole or protrusion using other similar methods. For example, the nanostructure tip may be deposited by opening only the portion in which the nanostructure tip is to be deposited and protecting the other portion not to be deposited using a protective material. As a method of growing the nanostructure tip, conventional methods may be used. Further, conventional methods of growing or etching nanosized materials, scull as chemical vapor deposition (CVD), arching, etching, deposition, and the like, can also be used as methods of growing the nanostructure tip. Furthermore, it is possible to attach a grown nanostructure tip to the hole or protrusion, but it is preferred that the nanostructure tip be directly grown, considering that it is aligned later. Therefore, the grown or attached nanostructure tip is constituted of one or more nanotubes, nanorods, nanopillars, nanoparticles, or the like.

It is preferred that the substrate be doped with a semiconductor such as silicon to be electrically conductive, and then used. When the thickness of the substrate is in a range of several micrometers to several tens of micrometers, the hole can be easily formed in the substrate. Further, it is preferred that the growth length of the nanostructure tip be considered.

As such, when the silicon substrate is etched to form the electron emitter, the etched portion of the silicon substrate is formed in a membrane shape. The electron emitter of the present invention may have the same form as an electron lens used in an electron column, such as a microcolumn. Therefore, when the electron emitter is aligned with the electron lens, as a method of combining lens holes with each other, a method of aligning lenses may be directly used.

Therefore, when the electron emitter according to the present invention is used, an electron column can be easily fabricated through a method of aligning lenses on a silicon substrate. Further, a voltage is applied to the highly-doped silicon portion of the electron emitter, so that all of the voltage is easily applied to the electron emitter, thereby easily controlling the electron column. Metallic membranes or general membranes can also be used as the substrate. Even in this case, since the metallic membranes or general membranes are very thin, light can pass through them.

Further, the electron emitter is formed by depositing or attaching the nanostructure tip to a thin silicon or metal membrane, so that the position of the nanostructure tip can be directly observed through a microscope using the light which passes through the membrane, with the result that the electron emitter can be more easily aligned with the aperture of the electron lens.

Further, when the nanostructure tip is located in the highly doped silicon portion formed by further etching or depositing the metal membrane or highly-doped silicon membrane, the nanostructure tip is located in the center of the U-shaped hole (concave or well) of the silicon substrate, is covered by surroundings, or is located at the central end of the ∩-shaped protrusion of the silicon substrate. When a voltage is applied to the nanostructure tip, a voltage is also applied to the highly doped silicon portion, so that a strong electromagnetic field is formed at the end of the nanostructure tip, thereby emitting electrons. In particular, in the case of the nanostructure tip and the U-shaped hole of the silicon substrate, a voltage is equally applied everywhere, and the voltage between both side of the U-shaped hole serves to prevent the divergent of the emitted electrons to the outside from the nanostructure tip, and thereby it has an effect of the decreasing the emission angle of an electron beam.

A substrate for providing nanotube or nanostructure tips may be made of metal or semiconductor material, which may be a conductive material through which identical voltage is applied to the tip and the U-shaped or ∩-shaped portion of the substrate. Here, since it is well known that silicon has high workability and is frequently used in etching processes, silicon is used as an example of the present invention.

In the electron emitter, when the top of the nanostructure tip is not accurately vertically aligned, the electrons emitted from the nanostructure tip cannot pass through an aperture or hole of an electron lens. In this case, since the nanostructure tip can be vertically aligned using an ion beam technique, an electron column can be easily fabricated using the electron emitter. In addition to the electron column, an electron beam apparatus used as an electron beam irradiation means can also be fabricated using the same method as in the fabrication of the electron column. In the alignment of the nanostructure tip using the ion beam technique, when a parallel ion beam is vertically applied to an electron lens and then a voltage is applied to the electron lens, the electron lens operates as a focus lens, so that the ion beam is focused at the position where the nanostructure tip is located, and simultaneously the nanostructure tip is vertically aligned according to the incident ion beam. In addition, the nanostructure tip can be vertically aligned by focusing the focused ion beam on the nanostructure tip through a hole of the electron lens.

Further, the present invention provides a method of aligning a nanostructure tip of an electron emitter, including: aligning an electron emitter provided with a nanostructure tip with an aperture of an electron lens layer through which electrons emitted from the electron emitter pass; and vertically irradiating an ion beam to the nanostructure tip through the aperture of the electron lens layer.

Therefore, in the present invention, the nanostructure tip is aligned with the electron lens layer base on a hole or protrusion provided with the nanostructure tip, and then realigned using the ion beam.

### ADVANTAGEOUS EFFECTS

The electron emitter having a nanostructure tip according to the present invention can be easily aligned because the nanostructure tip can be located at an accurate position using a semiconductor fabrication method.

Further, the electron emitter having a nanostructure tip according to the present invention can emit effective electrons by applying a voltage to the entire highly-doped silicon portion of a silicon substrate because the nanostructure tip is protruded into or out of the silicon substrate, and can be easily controlled.

Further, the electron emitter having a nanostructure tip according to the present invention can be fabricated at low cost and can be easily used in a multi electron column because an array of electron emitters can be formed on a substrate such as a silicon wafer. When the electron emitter is formed on the silicon wafer, it is individually cut as an electron lens, and is thus easily formed into an electron emitter for a single electron column or a multi electron column.

Furthermore, according to the electron emitter having a nanostructure tip of the present invention, since the electron emitter can be fabricated in the form of an electron lens, it can be easily aligned with electron lenses, particularly, electron lenses for a miniaturized electron beam column, so that a process for fabricating an electron column using the electron emitter can be easily conducted. Further, the electron emitter of the present invention can be easily used as an electron emitter for a multi electron column.

### BRIEF DESCRIPTION OF THE DRAWINGS

FIG. 1 is a schematic sectional view showing the structure of a miniaturized electron beam column;

FIG. 2 is a view showing a process of fabricating an electron emitter 100 according to the present invention;

FIG. 3 is a sectional view for explaining the structure of an electron emitter having a nanostructure tip according to the present invention;

FIG. 4 is a plan view and a sectional view showing an example of using the electron emitter having the nanostructure tip of the present invention in an electron column;

FIG. 5 a plan view and a sectional view showing an example of using the electron emitter having the nanostructure tip of the present invention in an electron column in the case where the electron column is a multi electron column;

FIG. 6 is a sectional view and a plan view showing another example of a silicon substrate of FIG. 5; and

FIG. 7 is a sectional view conceptually showing the irradiation of an ion beam in order to realign the nanostructure tip of the electron emitter of the present invention.

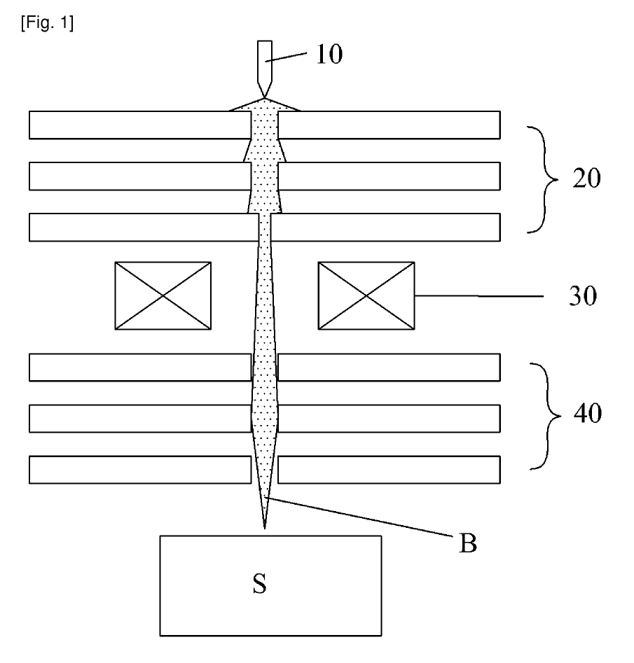

### MODE FOR THE INVENTION

Hereinafter, preferred embodiments of the present invention will be described in detail with reference to the accompanying drawings.

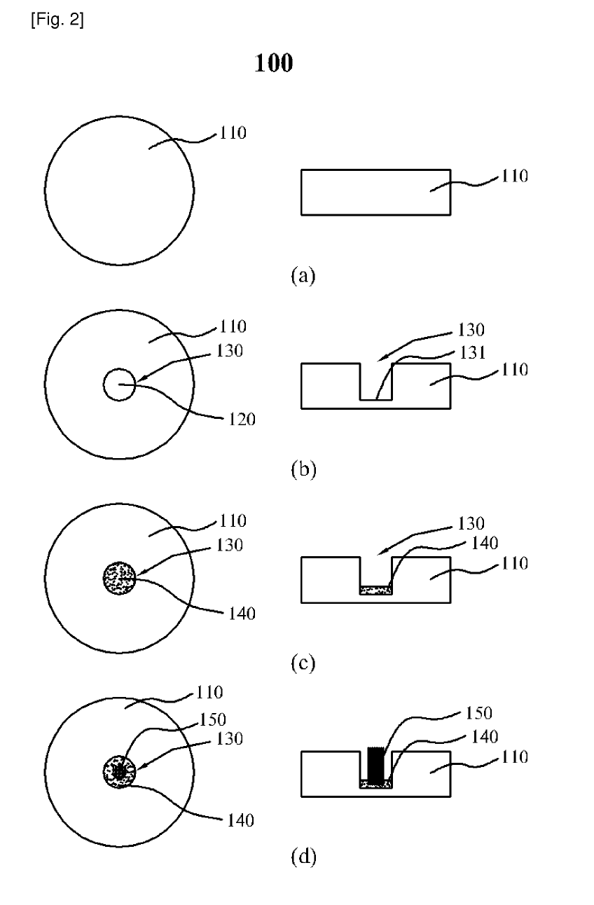

FIG. 2 is a view showing a process of fabricating an electron emitter 100 using a silicon wafer. FIGS. 2a to 2d show a process of depositing a nanostructure tip using a silicon wafer. Here, there are plan views at the left side of FIG. 2, and there are sectional views at the right side of FIG. 2.

First, FIG. 2a is a sectional view showing a disk-shaped silicon wafer 110. A nanostructure tip is used as a tip of an electron emitter by forming the nanostructure tip in the conductive silicon wafer 110, as a substrate. The silicon wafer 110 may have a thickness of several micrometers to several hundreds micrometers (μm). Instead of the silicon wafer, metal plates or general thin plates, which can be made in the form of membrane, may be used as the substrate. In the case of a nonconductive substrate, only the portion in which a tip is located may be treated with a conductor and then wired. Such a substrate is advantageous in that it is used in the form of a multi beam structure.

FIG. 2b shows the silicon wafer 110, in the center of which a hole 130 is formed. The hole 130 is formed through a semiconductor etching process, and the depth of the hole 130 must be set in order for the hole 130 not to pass through the silicon wafer 110. The thickness of the portion of the silicon wafer 110 located beneath the bottom of the hole 130 must be thin, like membrane. That is, the thickness of the portion of the silicon wafer 110 located beneath the bottom of the hole 130 is different from that of the remaining portion of the silicon wafer 110, so that, when laser light penetrates the silicon wafer 110, the laser light penetrating the portion of the silicon wafer 110 located beneath the bottom of the hole 130 is distinguished from the laser light penetrating the remaining portion of the silicon wafer.

In FIG. 2c, a catalyst 140 is put into the hole 130 such that a nanostructure tip is placed on the bottom 131 of the hole 130. The nanostructure tip is deposited on the catalyst 140. Here, assuming that the nanostructure tip is a nanoparticle tip, the nanoparticle tip can be fabricated only through deposition. In this case, the silicon wafer 110 is entirely covered with a protective film except for the portion in which a catalyst is put, and the nanoparticle tip is deposited on the catalyst, and then the protective film is removed therefrom, thereby fabricating a nanoparticle tip.

FIG. 2d shows a silicon wafer 110 in which a nanostructure tip 150 is deposited on the catalyst 140. In this case, it is preferred that the height of the nanostructure tip be equal to or less than that of the silicon substrate 110. In FIG. 2, one nanostructure tip is illustrated, but, if necessary, more than one may be used. One nanostructure tip may be used in electron microscopes, nanolithography, and the like, and several nanostructure tips may be used in scanning field emission display (SFEDs), and the like. That is, it is preferred that the number of the nanostructure tips be determined depending on the characteristics of the field in which the electron emitter is used.

Further, the hole 130 has a circular shape, but may also assume various polygonal shapes. The hole 130 may be formed by etching the silicon substrate 110 into these shapes. It is preferred that the shape of the hole 130 is the same as that of an aperture of an electron lens, and the size of the hole 130 be equal to or less than that of an aperture of an electron lens. The nanostructure tip deposited on the catalyst is shown in FIG. 2d, but a preformed nanostructure tip may be used by attaching it to the bottom of the hole 130 shown in FIG. 2c.

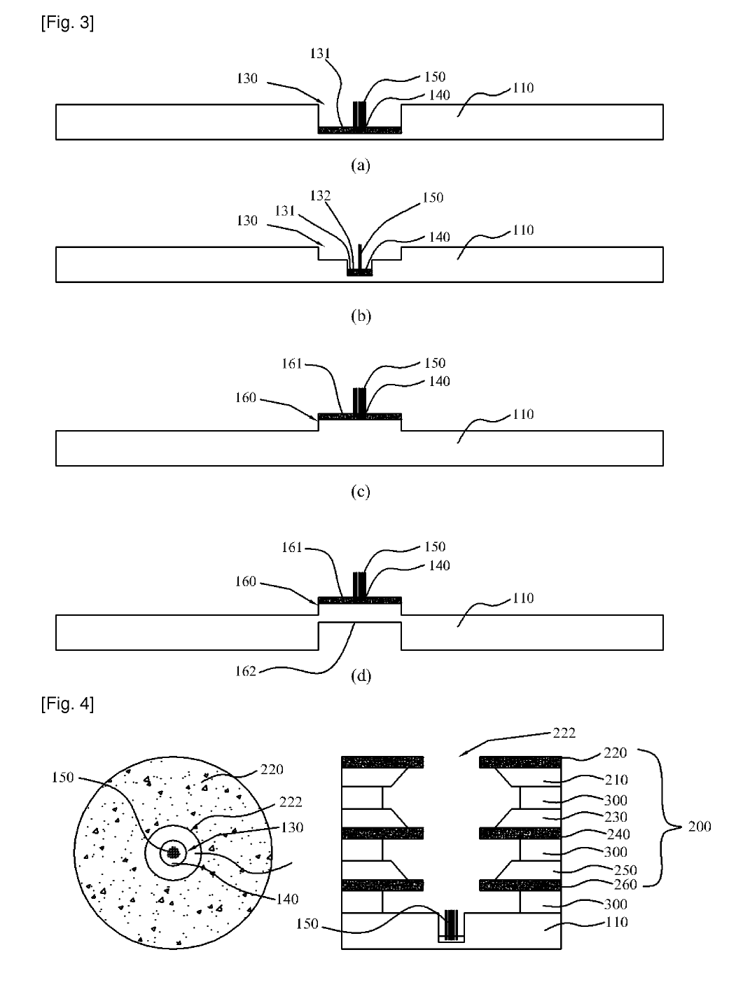

FIG. 3 is sectional views for explaining the structure of an electron emitter having a nanostructure tip according to the present invention. FIG. 3a shows a general electron emitter 100 of FIG. 2. FIG. 3b shows an electron emitter 100 in which a hole 130 is formed in two stages because the number or size of the nanostructure tip 150 is small. FIG. 3c shows an electron emitter 100 in which the nanostructure tip 150 is formed on a protrusion unlike the general electron emitter 100 of FIG. 2. FIG. 3d shows another electron emitter 100 in which the nanostructure tip 150 is formed on a protrusion.

The holes shown in FIGS. 3a and 3b and protrusions shown in FIGS. 3c and 3d may be used in order to align the apertures of electron lenses or deflectors required for fabricating an electron column. The nanostructure tip is located at the center of the hole or protrusion. Since the size of the nanostructure tip is very small, it is very difficult to confirm the position of the nanostructure tip at the time of aligning the nanostructure tip with the aperture of the electron lens. Therefore, the nanostructure tip can be easily aligned with the aperture of the electron lens by aligning the aperture of the electron lens based on the shape of the hole or protrusion provided with the nanostructure tip. If the nanostructure tip is not accurately located at the center of the hole or protrusion and thus a positioning error occurs, the nanostructure tip may be aligned with the aperture of the electron lens in consideration of the positioning error data based on the misplacement related to the hole or protrusion. That is, based on the positioning error data, the nanostructure tip may be aligned such that it is located at the center of an optical axis of an aperture of an electron lens or deflector in consideration of the degree that the nanostructure tip deviates from the center of the hole or protrusion.

First, in FIGS. 3a and 3b, explaining the relationship between the hole 130 and the nanostructure tip 150, it is preferred that the diameter of the hole 150, if possible, be small because the nanostructure tip 150 is influenced by the voltage transferred through the bottom 131 and wall of the hole 130.

Therefore, the size of the hole 130 is determined depending on the size of the nanostructure tip 150, and the nanostructure tip 150 is formed in the center of the hole 130 or 131 through deposition, attachment or etching. For ensuring the accurate positioning of the nanostructure tip 150 and an appropriate size of the hole 130, electron beam lithography may be used, and, in the case where the size of the hole 130 is on a micrometer scale, optical lithography may be used. The nanostructure tip 150 is formed in the center of the hole 130 by forming a lithographic pattern on the center of the hole 130 and then depositing a catalyst only on the lithographic pattern, etching only the lithographic pattern or attaching a tip only to the lithographic pattern, in order to maintain the distance between the nanostructure tip 150 and the wall of the hole 130. In this case, it is most preferred that the height of the nanostructure tip 150 be equal to that of the hole 130, and the height of the nanostructure tip 150 may be equal to or less than that of the used substrate, for example, the silicon substrate 110.

Here, if necessary, the hole 130 may be formed in two stages depending on the size of the hole 130. Moreover, it is possible to form the hole 130 in three or more stages, but it is generally sufficient to form the hole 130 in two stages.

In FIGS. 3c and 3d, the nanostructure tip 150 is formed on the center of a protrusion 160, instead of the hole 130. That is, the nanostructure tip 150 is formed on the center of the bottom 161 of the protrusion 160. In particular, in FIG. 3d, a hole 162 is formed on the opposite side of the protrusion 160 to have the same shape as the hole 130 of FIGS. 3a and 3b. The reason why the hole 162 is formed on the opposite side of the protrusion 160 is that the thickness of the protrusion is to be decreased to the same degree as was the thickness of the bottom of the hole 130. The hole 162 can be formed using the same method as was used regarding the hole 130.

FIG. 4 shows an example of using an electron emitter having the nanostructure tip of the present invention in an electron column. The left side of FIG. 4 is a plan view of the electron emitter provided at the lowermost layer thereof with the nanostructure tip, and the right side of FIG. 4 is a sectional view of the electron emitter.

In FIG. 4, a source lens 200 is provided on the electron emitter 100 according to the present invention. The source lens 100 includes three electrode layers. The electrode layers include highly-doped portions 220, 240 and 260 and silicon layers 210, 230 and 250, respectively. The electrode layers are highly doped on a silicon substrate to form a membrane, and an aperture 222 is formed in the center of the membrane such that an electron beam passes through the membrane. The lowermost electrode layer 250 and 260, which is called an extractor in an electron column, serves to enable the nanostructure tip 150 of the electron emitter 100 to easily emit electrons. The middle electrode layer 230 and 240, which is called an accelerator in an electron column, serves to accelerate the electrons emitted from the nanostructure tip 150. The uppermost electrode layer 210 and 220, which is called a limiting aperture in an electron column, serves to form the emitted electrons into an effective electron beam. That is, the source lens 200 chiefly serves to convert the electrons emitted from the electron emitter 100 into an electron beam, and also serves to perform focusing etc. If necessary, silicon layers 210, 230 and 250 may be removed.

In the source lens 200, insulating layers 300, made of such as Pyrex, are interposed between the electrode layers, respectively. Further, the insulating layer 300, made of such as Pyrex, is also interposed between the extractor and the electron emitter.

FIG. 4 shows an example of the use of the electron emitter according to the present invention. Therefore, the source lens itself may be combined with the electron emitter, but the electrode layers constituting the source lens may be layered on the silicon substrate of the electron emitter through a semiconductor process in order to satisfactorily meet the conveniences required pertaining to alignment and fabrication.

Further, the nanostructure tip 150 may be aligned with the aperture 222 of the source lens 200 by irradiating light or laser from under the membrane, or it may be aligned with the aperture 222 of the source lens 200 by irradiating light or laser through the aperture 222 of the source lens 200, while looking down the aperture 222 of the source lens from the membrane. In particular, it is possible to align the nanostructure tip 150 with the aperture 222 of the source lens 200 using an alignment key. The degree of alignment of the nanostructure tip 150 can be observed when this method is used.

The nanostructure tip 150 and source lens 200 are aligned with each other through a focused ion beam (FIB) method. The nanostructure tip 150 can be aligned by aligning it with an optical axis of the source lens 200.

FIG. 4 shows an example of combining an electron emitter with a source lens. However, the electron emitter can be easily aligned with other electrode layers, rather than with the source lens. Therefore, the electrode layers of FEDs or SFEDs can also be aligned with the electron emitter.

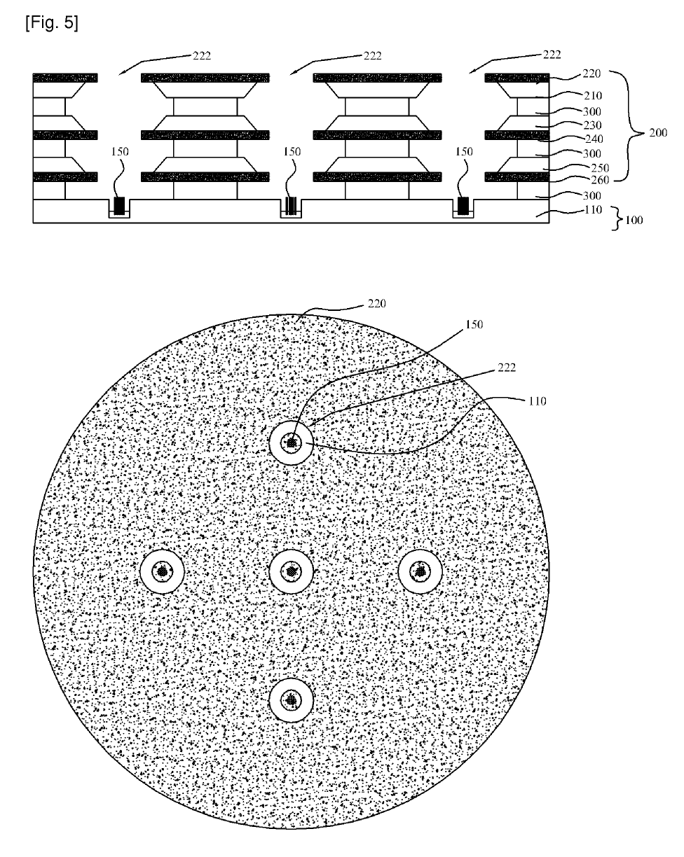

FIG. 5 shows a multi electron column. The multi electron column of FIG. 5 can be aligned using the same method as was used in that of the electron column of FIG. 4. Since the electron emitter 100 of FIG. 5 can be provided with a array of nanostructure tips 150 in the holes thereof, it can be aligned with an electron lens (particularly, a source lens) using the same method as in FIG. 3.

FIG. 5 shows a multi electron column including five unit electron columns, assuming that the unit electron column is one unit for forming the electrons emitted from each nanostructure tip into an electron beam. In FIG. 5, all of the nanostructure tips of an electron emitter are formed on one plate, and the same voltage is applied thereto. The plate may be made of a conductor or an insulating material. In the case where the plate is made of an insulating material, only the portion in which nanostructure tips are located may be treated with a conductor and then wired. It is preferred that a highly-doped silicon layer or metal layer be used as the plate. In this case, the electron beams emitted from the respective nanostructure tips to specimens have equivalent energy. Therefore, in the case where it is required to apply individually unique voltages to the nanostructure tips, voltages may be respectively applied to the respective nanostructure tips by individually dividing the plate around the nanostructure tips or by dividing the plate around the electrode layer adjacent to the electron emitter, so that the application of voltage can be controlled using the difference in voltage between each of the nanostructure tips and the adjacent electrode layer.

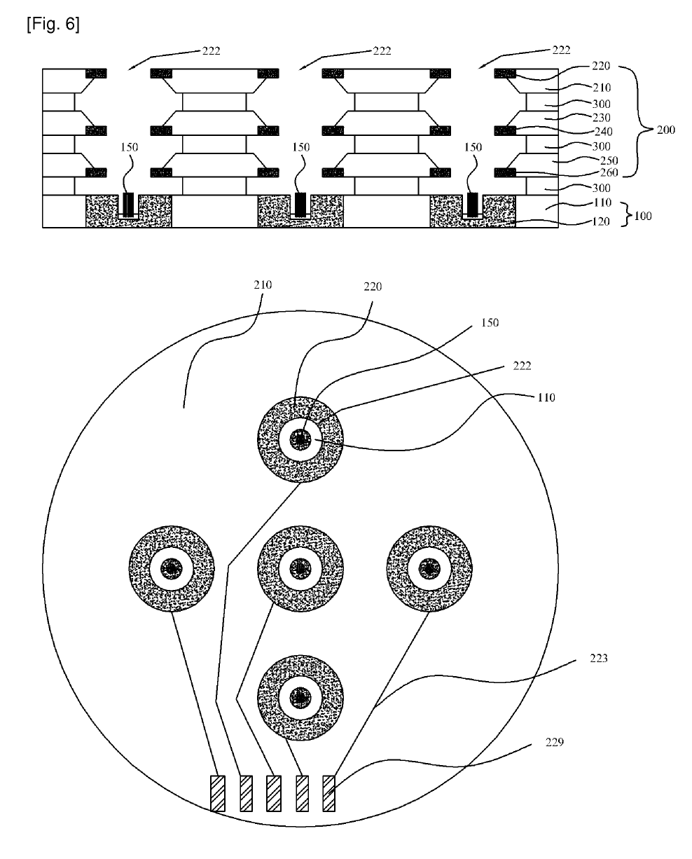

FIG. 6 shows another multi electron column.

Unlike FIG. 5, FIG. 6 shows a multi electron column in which a silicon substrate is insulated every unit electron emitter. Therefore, the silicon substrate is not doped or is partially doped to have insulating properties. Further, as shown in FIG. 6, doped portions 120 are formed in the substrate every nanostructure tip 150. In FIG. 6, the doped portions 120 and the electrode layers 220, 240 and 260 of the source lens 200 are separately highly-doped and formed every unit electron column. Further, in FIG. 6, since an electrode array 229 is formed on the doped portions 120 through wires 223, voltages are individually applied to the respective unit electron columns. In the case of the electron emitter, the doped portions 120 may be partially formed, and the wires and electrode array may be formed as above. The electron emitter of FIG. 6 is advantageous in that, in the multi electron column, it can be controlled by individually applying voltages to the nanostructure tips.

The multi electron column of FIG. 6 is additionally provided with another layer, so that electrodes, such as nanostructure tips, extractors corresponding to the nanostructure tips, and the like, can also be controlled every unit electron column.

The multi electron column of FIG. 5 or FIG. 6 is fabricated in the form of a wafer and then cut every unit electron column, so that the cut electron column can be independently used.

In the above examples, the shape of the aperture or hole may be changed into various polygonal shapes, and the shape of a silicon substrate may also be changed into various polygonal shapes, such as a rectangular shape, a square shape, and the like.

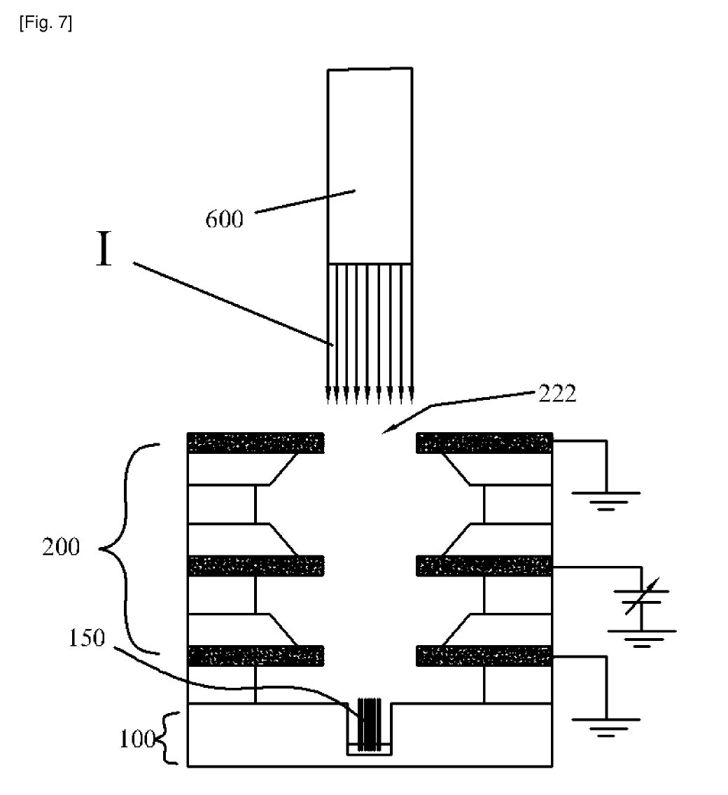

FIG. 7 is a sectional view conceptually showing the irradiation of an ion beam in order to realign the nanostructure tip of the electron emitter of the present invention.

In FIG. 7, an ion beam (I) is irradiated in a direction perpendicular to the optical axis of electron beam irradiation means, such as an electron column, using ion beam irradiation means 600 in order to vertically realign a nanostructure tip of the electron emitter after the primary alignment thereof. The realignment of the nanostructure tip is conducted using the phenomenon in which the inclination angle of the nanostructure tip is changed depending on the direction of the ion beam when the nanostructure tip is not accurately realigned vertically or is located at the place deviated from the optical axis. In FIG. 7, the ion beam (I) may be focused on the nanostructure tip by applying a voltage to each electrode layer of an electron lens. In this case, the ion beam (I) may also be focused on the nanostructure tip by variably applying a voltage to a middle electrode layer and by grounding upper and lower electrode layers or applying different voltages thereto. In this case, there is an advantage in that the nanostructure tip is completely aligned with a focus lens.

In FIGS. 4 to 6, three electrode layers are aligned and attached on an electron emitter, but, if necessary, a deflector or a focusing lens may be additionally aligned and attached (or deposited). It is preferred that a lens type deflector be used as the deflector.

### INDUSTRIAL APPLICABILITY

The electron emitter according to the present invention can be used for various electron columns. This electron emitter can be used for measuring and inspecting apparatuses using an electron beam, such as electron microscopes, surface measuring apparatuses, electron beam apparatuses for surface analysis, electron beam apparatuses for inspecting the defects of via-holes, CD-SEMs, apparatuses for inspecting electrical defects, apparatuses for inspecting the opening and closing of microcircuits, array inspection apparatuses, electron beam lithography, and the like in the field of semiconductor and display industries in which it is required to control the formation of electron beams.

1. An electron emitter, comprising:
a substrate including a blind hole or a protrusion formed at a predetermined location thereof; and
a nanostructure tip formed on a surface of the hole or protrusion;
wherein the surface of the hole or protrusion is formed into a membrane.

2. The electron emitter according to claim 1, wherein the shape of the hole or protrusion corresponds to that of an aperture or hole of an electron lens which is to be aligned with the electron emitter, and the size of the hole or protrusion is equal to or less than that of the aperture or hole of the electron lens.

3. The electron emitter according to claim 1, wherein a conductor layer such as a metal layer, a semiconductor layer such as a silicon layer, or a nonconductive layer is used as the substrate, and the semiconductor layer is partially highly-doped to cover the nanostructure tip when it is made of nonconductive silicon, and the nonconductive layer is provided with a conductive portion to enclose the nanostructure tip.

4. The electron emitter according to claim 3, wherein the highly-doped portion of the semiconductor layer or the conductive portion of the nonconductive layer is wired such that an external voltage is individually applied thereto.

5-13. (canceled)

14. The electron emitter according to claim 2, wherein a conductor layer such as a metal layer, a semiconductor layer such as a silicon layer, or a nonconductive layer is used as the substrate, and the semiconductor layer is partially highly-doped to cover the nanostructure tip when it is made of nonconductive silicon, and the nonconductive layer is provided with a conductive portion to enclose the nanostructure tip.

15. The electron emitter according to claim 14, wherein the highly-doped portion of the semiconductor layer or the conductive portion of the nonconductive layer is wired such that an external voltage is individually applied thereto.

16. The electron emitter according to claim 1, wherein the nanostructure tip is formed in the hole, and the nanostructure tip is located under a top surface of the substrate, so that an identical voltage is applied around the nanostructure tip.

17. The electron emitter according to claim 2, wherein the nanostructure tip is formed in the hole, and the nanostructure tip is located under a top surface of the substrate, so that an identical voltage is applied around the nanostructure tip.

18. The electron emitter according to claim 3, wherein the nanostructure tip is formed in the hole, and the nanostructure tip is located under a top surface of the substrate, so that an identical voltage is applied around the nanostructure tip.

19. The electron emitter according to claim 4, wherein the nanostructure tip is formed in the hole, and the nanostructure tip is located under a top surface of the substrate, so that an identical voltage is applied around the nanostructure tip.

20. The electron emitter according to claim 14, wherein the nanostructure tip is formed in the hole, and the nanostructure tip is located under a top surface of the substrate, so that an identical voltage is applied around the nanostructure tip.

21. The electron emitter according to claim 1, wherein a catalyst layer, an adhesive layer or an etching layer is formed on the hole or protrusion, and the nanostructure tip grows, adheres or protrudes on the catalyst layer, adhesive layer or etching layer.

22. The electron emitter according to claim 1, wherein the substrate includes two or more holes or protrusions, and the two or more holes or protrusions are provided thereon with nanostructure tips, respectively.

23. The electron emitter according to claim 2, wherein the substrate includes two or more holes or protrusions, and the two or more holes or protrusions are provided thereon with nanostructure tips, respectively.

24. The electron emitter according to claim 3, wherein the substrate includes two or more holes or protrusions, and the two or more holes or protrusions are provided thereon with nanostructure tips, respectively.

25. The electron emitter according to claim 4, wherein the substrate includes two or more holes or protrusions, and the two or more holes or protrusions are provided thereon with nanostructure tips, respectively.

26. The electron emitter according to claim 16, wherein the substrate includes two or more holes or protrusions, and the two or more holes or protrusions are provided thereon with nanostructure tips, respectively.

27. A electron beam irradiation means comprising;
an electron emitter, comprising
a substrate including a blind hole or a protrusion formed at a predetermined location thereof; and
a nanostructure tip formed on a surface of the hole or protrusion; and
one or more electron lenses and one or more deflectors;
wherein the surface of the hole or protrusion is formed into a membrane;
wherein the electron lens and deflector constitutes an electron column having apertures corresponding to a hole or protrusion of the electron emitter.

28. The electron beam irradiation means according to claim 27, wherein the electron beam irradiation means comprises a source lens, a deflector and a focus lens; and
wherein the source lens, the source lens and focus lens, or the source lens deflector and focus lens constitute a multi electron column having apertures corresponding to the number of electron beams emitted from the electron emitter.

29. The electron beam irradiation means according to claim 27, wherein the shape of the hole or protrusion corresponds to that of an aperture or hole of an electron lens which is to be aligned with the electron emitter, and the size of the hole or protrusion is equal to or less than that of the aperture or hole of the electron lens.

30. The electron beam irradiation means according to claim 29, wherein the electron beam irradiation means comprises a source lens, a deflector and a focus lens; and
wherein the source lens, the source lens and focus lens, or the source lens deflector and focus lens constitute a multi electron column having apertures corresponding to the number of electron beams emitted from the electron emitter.

31. The electron beam irradiation means according to claim 27, wherein a conductor layer such as a metal layer, a semiconductor layer such as a silicon layer, or a nonconductive layer is used as the substrate, and the semiconductor layer is partially highly-doped to cover the nanostructure tip when it is made of nonconductive silicon, and the nonconductive layer is provided with a conductive portion to enclose the nanostructure tip.

32. The electron beam irradiation means according to claim 31, wherein the electron beam irradiation means comprises a source lens, a deflector and a focus lens; and
wherein the source lens, the source lens and focus lens, or the source lens deflector and focus lens constitute a multi electron column having apertures corresponding to the number of electron beams emitted from the electron emitter.

33. The electron beam irradiation means according to claim 27, wherein the nanostructure tip is formed in the hole, and the nanostructure tip is located under a top surface of the substrate, so that an identical voltage is applied around the nanostructure tip.

34. The electron beam irradiation means according to claim 33, wherein the electron beam irradiation means comprises a source lens, a deflector and a focus lens; and
wherein the source lens, the source lens and focus lens, or the source lens deflector and focus lens constitute a multi electron column having apertures corresponding to the number of electron beams emitted from the electron emitter.

35. A method of aligning an electron emitter with an electron lens or a deflector in an electron beam irradiation means, wherein an aperture of the electron lens or an aperture of the deflector is aligned based on the shape of the hole or protrusion of an electron emitter, comprising:
a substrate including a blind hole or a protrusion formed at a predetermined location thereof; and
a nanostructure tip formed on a surface of the hole or protrusion;
wherein the surface of the hole or protrusion is formed into a membrane.

36. The method according to claim 35, wherein, when the nanostructure tip is not located in the center of the hole or protrusion, error values are measured, and then the nanostructure tip is aligned in consideration of the measured error values such that it is located on an optical axis of the electron beam irradiation means.

37. The method according to claim 35, wherein, wherein the shape of the hole or protrusion corresponds to that of an aperture or hole of an electron lens which is to be aligned with the electron emitter, and the size of the hole or protrusion is equal to or less than that of the aperture or hole of the electron lens.

38. The method according to claim 37, wherein, when the nanostructure tip is not located in the center of the hole or protrusion, error values are measured, and then the nanostructure tip is aligned in consideration of the measured error values such that it is located on an optical axis of the electron beam irradiation means.
